(19) United States
(12) Patent Application Publication
(10) Pub. No.: US 2026/0049189 A1
(43) Pub. Date: Feb. 19, 2026

(54) OVERMOLDED THERMOPLASTIC ARTICLES FORMED FROM HIGH-PURITY RECOVERED THERMOPLASTIC ELASTOMER MATERIALS

(71) Applicant: AVIENT CORPORATION, Avon Lake, OH (US)

(72) Inventors: Sharon MA, North Ridgeville, OH (US); Jian ZHOU, Avon, OH (US); Benjamin MESSMORE, Bay Village, OH (US); William PEPE, Ringwood, IL (US)

(21) Appl. No.: 19/101,669

(22) PCT Filed: Aug. 10, 2023
(86) PCT No.: PCT/US2023/071977

§ 371 Date: Feb. 6, 2025

Related U.S. Application Data
(60) Provisional application No. 63/397,138, filed on Aug. 11, 2022.

(51) Int. Cl. C08J 5/12; A45C 11/00; B03C 1/01; B03C 1/20; C08K 3/08; C08K 3/22; C08L 69/00; C08L 75/04; H04M 1/02

(52) U.S. Cl. CPC C08J 5/121; A45C 11/002; A45C 11/003; B03C 1/01; C08K 3/08; C08K 3/22; C08L 69/00; C08L 75/04; B03C 1/20; B03C 2201/20; C08J 2369/00; C08J 2375/04; C08K 2003/0856; C08K 2003/2275; C08K 2201/01; C08L 2207/04; C08L 2207/20; H04M 1/0203

(57) ABSTRACT

Overmolded thermoplastic articles include a base component comprising rigid thermoplastic material and an overmold component comprising recovered thermoplastic elastomer material. The recovered thermoplastic elastomer material includes, based on weight of the recovered thermoplastic elastomer material, greater than or equal to about 97 wt % of antecedent thermoplastic elastomer material and less than or equal to about 3 wt % of antecedent rigid thermoplastic material. The recovered thermoplastic elastomer material is obtained from an antecedent separation process in which the antecedent thermoplastic elastomer material is separated from at least a portion of the antecedent rigid thermoplastic material.

### CLAIM OF PRIORITY

This application claims priority from U.S. Provisional Patent Application Ser. No. 63/397,138 bearing Attorney Docket Number 1202207-US-F and filed on Aug. 11, 2022, which is hereby incorporated by reference in its entirety.

### TECHNICAL FIELD

The present disclosure relates to thermoplastic articles, and, more particularly, overmolded thermoplastic articles formed from high-purity recovered thermoplastic elastomer materials which may be obtained from an antecedent separation process.

### BACKGROUND

Multicomponent thermoplastic articles which have two or more components formed from dissimilar plastic materials may be used for achieving multiple functionalities in various applications, including protective cases for personal electronics such as smartphones, tablets, laptops, and the like. Various industries, including the consumer electronics industry, desire thermoplastic articles that include increasingly higher content of post-consumer and/or post-industrial recycled materials. However, it may be difficult to obtain high-purity materials from post-consumer recycling and post-industrial recycling of multicomponent thermoplastic articles.

Accordingly, a need exists for multicomponent thermoplastic articles formed from high-purity recovered thermoplastic elastomer materials.

### SUMMARY

Embodiments of the present disclosure are directed to overmolded thermoplastic articles formed from high-purity recovered thermoplastic elastomer materials.

According to some embodiments, an article is provided. The article comprises a base component comprising rigid thermoplastic material and an overmold component comprising recovered thermoplastic elastomer material. The recovered thermoplastic elastomer material comprises, based on weight of the recovered thermoplastic elastomer material, greater than or equal to about 97 wt % of antecedent thermoplastic elastomer material and less than or equal to about 3 wt % of antecedent rigid thermoplastic material. The recovered thermoplastic elastomer material may be obtained from an antecedent separation process in which the antecedent thermoplastic elastomer material is separated from at least a portion of the antecedent rigid thermoplastic material.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 is a schematic view of an exemplary article, according to one or more embodiments shown and described herein;

FIG. 2 is a schematic view of an exemplary configuration of a magnetic pulley separator, according to one or more embodiments shown and described herein;

FIG. 3 is a schematic view of another exemplary article, according to one or more embodiments shown and described herein;

FIG. 4 is a schematic view of another exemplary article, according to one or more embodiments shown and described herein;

FIG. 5 is a schematic view of another exemplary article, according to one or more embodiments shown and described herein; and

FIG. 6 is a schematic view of another exemplary configuration of a magnetic pulley separator, according to one or more embodiments shown and described herein.

### DETAILED DESCRIPTION

Reference is made hereinafter in detail to various embodiments of articles and processes related thereto.

Articles disclosed herein comprise a base component comprising rigid thermoplastic material and an overmold component comprising recovered thermoplastic elastomer material. The recovered thermoplastic elastomer material comprises, based on weight of the recovered thermoplastic elastomer material, greater than or equal to about 97 wt % of antecedent thermoplastic elastomer material and less than or equal to about 3 wt % of antecedent rigid thermoplastic material. The recovered thermoplastic elastomer material may be obtained from an antecedent separation process in which the antecedent thermoplastic elastomer material is separated from at least a portion of the antecedent rigid thermoplastic material.

The disclosure should not be construed as limited to the embodiments set forth herein. Rather, these embodiments are provided so that this disclosure will be thorough and complete, and will fully convey the subject matter to those skilled in the art.

### Definitions

Unless otherwise expressly defined, all technical and scientific terms used herein have the same meaning as commonly understood by a person of ordinary skill in the art. The terminology used in the disclosure herein is for describing particular embodiments only and is not intended to be limiting.

Unless otherwise expressly stated, it is not intended that any method disclosed herein be construed as requiring that its steps be performed in a specific order, nor that any apparatus article set forth herein be construed as requiring specific orders or orientations to its individual components.

Unless otherwise expressly stated, it is intended that any composition or mixture disclosed herein may comprise, consist essentially of, or consist of the disclosed components.

As used herein, the singular form of a term is intended to include the plural form of the term, unless the context clearly indicates otherwise.

As used herein, numerical values are not strictly limited to the exact numerical value recited. Instead, unless otherwise expressly stated, each numerical value is intended to mean both the exact numerical value and “about” the numerical value which encompasses (i.e., a functionally equivalent range surrounding that numerical value), such that either possibility is contemplated as an embodiment disclosed herein.

As used herein, the term “300% tensile modulus” refers to a stress value for a material at 300% strain as measured according to ASTM D412.

As used herein, the term “antecedent” refers to an article formed or a material prepared or a process that occurred earlier in time relative to another article or material or process as described herein.

As used herein, the term “dielectric constant” refers to the dielectric constant of a material as measured according to a resonant cavity method with frequencies between 35 and 42 GHz, with a dielectric constant measured at 40 GHz being representative of the frequency range.

As used herein, the term “essentially free” refers to when used to describe the amount and/or absence of a particular component, means that the component is not intentionally added. However, in embodiments, the component may be present in an amount of less than 0.1 wt % or 0.05 wt % or 0.03 wt % or 0.01 wt % or 0.005 wt % or 0.001 wt %.

As used herein, the term “flexural modulus” refers the ratio of stress to strain in flexural deformation as measured according to ASTM D790 at 23° C. and a rate of strain 0.2 mm/min.

As used herein, the term “formed from” (including related terms such as “forming”) refers to, with respect to an article (or component of an article) and a thermoplastic material, that the article (or component of the article) is extruded, molded, shaped, pressed, or otherwise made, in whole or in part, from the thermoplastic material under sufficient heating to enable such forming. As such, the term “formed from” (including related terms such as “forming”) means, in some embodiments, the article (or component of an article) can comprise, consist essentially of, or consist of, the material; and, in other embodiments, the article (or component of an article) consists of the material because the article (or component of an article) is, for example, made by an extrusion process or a molding process.

As used herein, the term “high-purity” refers to a composition or mixture in which a particular substance or material is present in an amount greater than or equal to, in various embodiments, 80 wt %, or 85 wt %, or 90 wt %, or 92 wt %, or 95 wt %, or 97 wt %, or 98 wt %, or 99 wt %, or 99.5 wt %, or 99.9 wt %.

As used herein, the term “neat” refers to a substance or material that is pure or substantially pure such that it is present as a single distinct substance or material without any other distinct substance(s) or material(s) being present in combination at level(s) greater than trace amount(s) using methodology and equipment that are conventional for detecting such substance(s) or material(s).

As used herein, the term “recovered” refers to a material coming from a recycled source.

As used herein, the term “Shore A hardness” refers to the hardness of a material, as measured according to ASTM D2240.

As used herein, the term “specific gravity” refers to the ratio of the density of a material to the density of water and is measured according to ASTM D792.

As used herein, the term “tensile elongation” refers to the tensile elongation at break, which is the ratio between increased length and initial length after breakage as measured according to ASTM D412, Die C.

As used herein, the term “tensile strength” refers to the tensile strength at break, which is the maximum stress that a material can withstand while stretching before breaking as measured according to ASTM D412, Die C.

As used herein, the term “virgin” refers to a material coming from a source other than a recycled source.

As used herein, the term “subsequent” refers to an article formed or a material prepared or a process that occurred later in time relative to another article or material or process as described herein.

### Usefulness

As discussed hereinabove, multicomponent thermoplastic articles which have two or more components formed from dissimilar plastic materials, such as overmolded thermoplastic articles, may be used for achieving multiple functionalities in various applications, including protective cases for personal electronics such as smartphones, tablets, laptops, and the like. For example, an elastomeric component may be bonded to a rigid resin component to provide a balanced performance, including overall stiffness, impact resistance, and shock absorption, while also providing desired aesthetics (look or appearance) and/or haptics (touch or feel).

Various industries, including the consumer electronics industry, desire thermoplastic articles that include increasingly higher content of post-consumer and/or post-industrial recycled materials. However, it may be difficult to obtain high-purity materials, particularly high-purity thermoplastic elastomer, from post-consumer recycling and post-industrial recycling of multicomponent thermoplastic articles.

In a conventional recycling process, multicomponent articles may be granulated, separated, and reprocessed (e.g., melted and extruded) for further use. Conventional material separation methods for a plastic regrind include float-sink method (density based), centrifuge method (density based), electrostatic sorting, optical sorting using near-infrared spectroscopy, and magnetic separation. Multicomponent articles with a thermoplastic elastomer overmold layer on a rigid thermoplastic base layer are typically designed to have strong interfacial bonding between the thermoplastic elastomer overmold layer and the rigid thermoplastic base layer to endure normal wear and tear and even mechanical abuses of the articles during use. Strong interfacial bonding often can survive an industrial grinding process involving mechanical shearing, tearing, and cutting of the articles for recycling purpose, resulting in a significant portion of hybrid particles having both a thermoplastic elastomer portion and a rigid thermoplastic portion among the regrind of such articles. The hybrid particles would typically be regarded as an undesirable contaminant in either a thermoplastic elastomer rich fraction or a rigid thermoplastic rich fraction that may be obtained by a conventional separation process. The separated and recovered thermoplastic elastomer rich fraction may still have a high level of the rigid thermoplastic material due to the presence of the hybrid particles after the conventional separation process, which negatively affects the properties of the recovered thermoplastic elastomer material.

Therefore, currently, multicomponent articles, such as overmolded thermoplastic articles, cannot practically be recycled to provide recovered materials with high purity, and recovered materials typically are suitable for further uses in forming new articles only after mixing with relatively larger amounts of virgin resin (e.g., more virgin resin than recycled resin in a mixture of virgin resin and recycled resin).

The articles disclosed herein address the aforementioned problems.

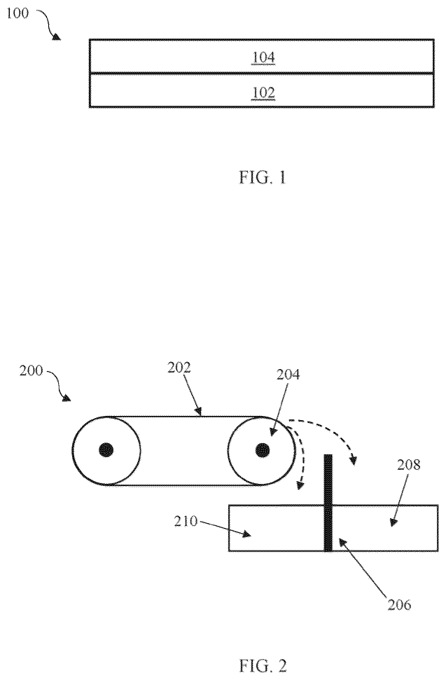

Referring now to FIG. 1, the articles 100 disclosed herein comprise a base component 102 and an overmold component 104. The base component 102 comprises rigid thermoplastic material and the overmold component 104 comprising recovered thermoplastic elastomer material. The recovered thermoplastic elastomer material comprises, based on weight of the recovered thermoplastic elastomer material, greater than or equal to about 97 wt % of antecedent thermoplastic elastomer material and less than or equal to about 3 wt % of antecedent rigid thermoplastic material. The recovered thermoplastic elastomer material may be provided from an antecedent separation process.

### Separation Process

In embodiments, the recovered thermoplastic elastomer material may be provided from an antecedent separation process in which antecedent thermoplastic elastomer material may be separated from at least a portion of antecedent rigid thermoplastic material to provide the recovered thermoplastic elastomer material.

For example, the recovered thermoplastic elastomer material may comprise regrind of an antecedent article and/or antecedent scrap material provided from an antecedent process for manufacturing and/or recycling the antecedent article, wherein the antecedent article and/or antecedent scrap material may comprise the antecedent thermoplastic elastomer material overmolded onto the antecedent rigid thermoplastic material, and wherein the regrind of the antecedent article and/or antecedent scrap material may be subjected to the antecedent separation process in which the antecedent thermoplastic elastomer material may be separated from at least a portion of the antecedent rigid thermoplastic material to provide the recovered thermoplastic elastomer material.

In embodiments, the antecedent separation process may comprise a step of providing or obtaining an antecedent article. In embodiments, the antecedent article may comprise an antecedent base component comprising antecedent rigid thermoplastic material and an antecedent overmold component comprising antecedent thermoplastic elastomer material, which may be the same as or similar to the structure of the article shown in FIG. 1.

In embodiments, the antecedent separation process may further comprise a step of reducing the antecedent article. In embodiments, the reducing step may comprise crushing, shredding, grinding, granulation, or a combination thereof to produce regrind. In some embodiments, such as post-consumer recycling processes, the reducing step may comprise reducing the antecedent article itself to produce regrind of the antecedent article. In other embodiments, such as post-industrial applications, the reducing step may comprise reducing antecedent scrap material from an antecedent process for manufacturing the antecedent article to produce regrind of the antecedent scrap material. In such embodiments, the antecedent scrap material may comprise the antecedent thermoplastic elastomer material overmolded onto the antecedent rigid thermoplastic material.

To facilitate the separation process, the antecedent rigid thermoplastic material may comprise a separation additive as further described elsewhere herein. The separation additive in the antecedent rigid thermoplastic material may be the separation additive described elsewhere herein with respect to the rigid thermoplastic material of the base component shown in FIG. 1.

In embodiments, the antecedent separation process may further comprise a step of separating the regrind of the antecedent article such that the antecedent thermoplastic elastomer material is separated from at least a portion of the antecedent rigid thermoplastic material to provide the recovered thermoplastic elastomer material.

For example, referring now to FIG. 2, in embodiments which include a magnetic separation additive in the antecedent rigid thermoplastic material, a magnetic roll separator 200 may be used. The magnetic roll separator 200 includes a belt conveyor 202 and a magnetic roll 204. The separator 200 includes a splitter 206 and two collection bins 208, 210. In other embodiments, additional splitters and collection bins may be included to allow for separation into more than two fractions. The collection bin 208 collects regrind without magnetic separation additive (e.g., recovered thermoplastic elastomer material) and the collection bin 210 collects regrind with magnetic separation additive (e.g., recovered rigid thermoplastic material). The splitter 206 may be adjustable to achieve high-purity recovered thermoplastic elastomer material.

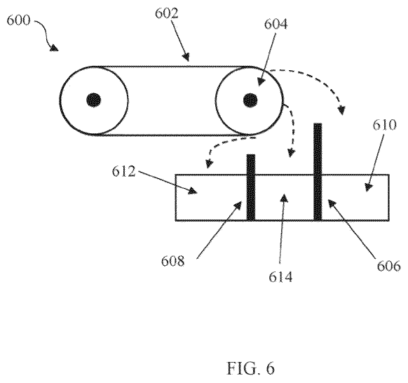

For further example, referring now to FIG. 6, another magnetic pulley separator 600 includes a belt conveyor 602 and a magnetic roll 604. The separator 600 includes two splitters 606, 608 and three collection bins 610, 612, 614. In other embodiments, additional splitters and collection bins may be included to allow for separation into more than three fractions. The configuration of the splitters 606, 608 may be adjustable depending on other operating conditions. The collection bin 610 collects predominantly regrind particles of the component material that does not contain the magnetic separation additive, the collection bin 612 collects predominantly regrind particles of the component material that contains the magnetic separation additive, and the collection bin 614 collects predominantly “hybrid” regrind particles.

When a density separation additive is added to the antecedent rigid thermoplastic material, a static type floatation tank with specified medium may be used to facilitate the separation process. The specified medium has an intermediate density of the thermoplastic elastomer material without density separation additive and rigid thermoplastic material with density separation additive. The lower density regrind (e.g., the thermoplastic elastomer material without density separation additive) float whereas those of higher density regrind (e.g., the rigid thermoplastic material with density separation additive) sink.

### Article

Referring again to FIG. 1, the articles 100 disclosed herein comprise a base component 102 and an overmold component 104.

In embodiments, at least a portion of the overmold component 104 may be affixed by interfacial bonding onto at least a portion of the base component 102.

In embodiments, the overmold component 104 may be molded onto at least one side of the base component 102. For example, a typical overmolding process may include pressing a melt of overmold component 104 onto at least one side of the previously formed base component 102 in a molding cavity and then cooling to form the article 100. With a typical overmolding process, the base component 102 and the overmold component 104 may be bonded to each other without the need for adhesive.

In embodiments, the bond between the base component 102 and the overmold component 104 is relatively strong such that a regrind mixture obtained by physically reducing (e.g., grinding) the article 100 and having an average particle size between about 1 mm and about 10 mm may include at least 10 wt % of hybrid particles (i.e., particles having at least one portion consisting of the base component 102 and at least one other portion consisting of the overmold component 104), based on a total weight of the regrind.

In embodiments, the articles 100 disclosed herein may further comprise one or more additional components comprising one or more additional thermoplastic materials, as described hereinafter.

In embodiments, the articles 100 disclosed herein may further comprise a photoluminescent marker.

In embodiments, an antecedent article may comprise a base component comprising an antecedent rigid thermoplastic material and an overmold component comprising an antecedent thermoplastic elastomer material, and otherwise may be the same as or different from the articles as described herein.

### Base Component and Rigid Thermoplastic Material

As disclosed herein, the base component 102 comprises rigid thermoplastic material.

In embodiments, the base component 102 may be formed from the rigid thermoplastic material.

In embodiments, the base component may comprise rigid thermoplastic material, separation additive, and optional other additives.

In embodiments, the rigid thermoplastic material may comprise thermoplastic resin, separation additive, and optional other additives.

In embodiments, the antecedent rigid thermoplastic material may be the same as or different from the rigid thermoplastic material as described herein.

In embodiments, the base component and/or the rigid thermoplastic material may have a flexural modulus greater than or equal to about 1000 MPa or greater than or equal to about 1200 MPa; and, less than or equal to about 3000 MPa or less than or equal to about 2500 MPa; for example, from about 1000 MPa to about 3000 MPa, from about 1000 MPa to about 2500 MPa, from about 1500 MPa to about 3000 MPa, or from about 1500 MPa to about 2500 MPa, or any and all subranges formed from any of these endpoints.

In embodiments, the base component and/or the rigid thermoplastic material may have a density greater than or equal to about 1.0 g/cm³ or greater than or equal to about 1.1 g/cm³; and, less than or equal to about 1.3 g/cm³ or less than or equal to about 1.2 g/cm³; for example, from about 1.0 g/cm³ to about 1.3 g/cm³, from about 1.0 g/cm³ to about 1.2 g/cm³, from about 1.1 g/cm³ to about 1.3 g/cm³, or from about 1.1 g/cm³ to about 1.2 g/cm³, or any and all subranges formed from any of these endpoints.

### Thermoplastic Resin

In embodiments, the rigid thermoplastic material may comprise thermoplastic resin.

Suitable thermoplastic resins may include conventional or commercially available thermoplastic resins. A thermoplastic resin may be used alone or in combination with one or more other thermoplastic resins.

In embodiments, the thermoplastic resin may be selected from the group consisting of polycarbonates, thermoplastic polyesters, polyamides, aliphatic polyketones, acrylonitrile butadiene styrenes, polypropylenes, and combinations thereof.

In embodiments, the thermoplastic resin may be selected from virgin thermoplastic resin, recycled (recovered) thermoplastic resin, or combinations thereof.

Suitable commercial embodiments of thermoplastic resin are available under the MARKROLON brand from Covestro, such as polycarbonate grade 2407.

In embodiments, the thermoplastic resin may be present in the rigid thermoplastic material in an amount from about 50 wt % to about 99.95 wt %, based on weight of the rigid thermoplastic material, or any and all subranges formed between these endpoints. For example, in embodiments, the thermoplastic resin may be present in an amount in the rigid thermoplastic material from about 60 wt % to about 99.95 wt %, or from about 70 wt % to about 99.95 wt %, or from about 80 wt % to about 99.95 wt %, or from about 90 wt % to about 99.95 wt %, or from about 95 wt % to about 99.95 wt %, based on weight of the rigid thermoplastic material, or any and all subranges formed between any of these endpoints.

### Separation Additive

In embodiments, the rigid thermoplastic material may comprise separation additive to facilitate a subsequent separation process as described elsewhere herein.

In embodiments, the separation additive may be present in the rigid thermoplastic material in an amount from about 0.05 wt % to about 10 wt %, based on weight of the rigid thermoplastic material, or any and all subranges formed between these endpoints.

For example, in embodiments, the amount of separation additive in the rigid thermoplastic material may be, based on weight of the rigid thermoplastic material, greater than or equal to about 0.05 wt %, greater than or equal to about 0.1 wt %, greater than or equal to about 0.2 wt %, greater than or equal to about 0.5 wt %, greater than or equal to about 1 wt %, greater than or equal to about 3 wt %, greater than or equal to about 5 wt %, greater than or equal to about 5.5 wt %, greater than or equal to about 6 wt %, greater than or equal to about 6.5 wt %, or greater than or equal to about 7 wt %; and, less than or equal to about 10 wt %, less than or equal to about 9 wt %, less than or equal to about 8.5 wt %, less than or equal to about 8 wt %, less than or equal to about 6 wt %, less than or equal to about 4 wt %, less than or equal to about 2 wt %, less than or equal to about 1 wt %, or less than or equal to 0.5 wt %; for example, from about 0.05 wt % to about 10 wt %, from about 0.05 wt % to about 9.5 wt %, from about 0.05 wt % to about 9 wt %, from about 0.05 wt % to about 8.5 wt %, from about 0.05 wt % to about 8 wt %, from about 0.05 wt % to about 6 wt %, from about 0.05 wt % to about 4 wt %, from about 0.05 wt % to about 2 wt %, from about 0.05 wt % to about 1 wt %, from about 0.05 wt % to about 0.5 wt %, from about 0.1 wt % to about 10 wt %, from about 0.1 wt % to about 9.5 wt %, from about 0.1 wt % to about 9 wt %, from about 0.1 wt % to about 8.5 wt %, from about 0.1 wt % to about 8 wt %, from about 0.1 wt % to about 6 wt %, from about 0.1 wt % to about 4 wt %, from about 0.1 wt % to about 2 wt %, from about 0.1 wt % to about 1 wt %, from about 0.1 wt % to about 0.5 wt %, from about 0.2 wt % to about 10 wt %, from about 0.2 wt % to about 9.5 wt %, from about 0.2 wt % to about 9 wt %, from about 0.2 wt % to about 8.5 wt %, from about 0.2 wt % to about 8 wt %, from about 0.2 wt % to about 6 wt %, from about 0.2 wt % to about 4 wt %, from about 0.2 wt % to about 2 wt %, from about 0.2 wt % to about 1 wt %, from about 0.2 wt % to about 0.5 wt %, from about 0.5 wt % to about 10 wt %, from about 0.5 wt % to about 9.5 wt %, from about 0.5 wt % to about 9 wt %, from about 0.5 wt % to about 8.5 wt %, from about 0.5 wt % to about 8 wt %, from about 0.5 wt % to about 6 wt %, from about 0.5 wt % to about 4 wt %, from about 0.5 wt % to about 2 wt %, from about 0.5 wt % to about 1 wt %, from about 1 wt % to about 10 wt %, from about 1 wt % to about 9.5 wt %, from about 1 wt % to about 9 wt %, from about 1 wt % to about 8.5 wt %, from about 1 wt % to about 8 wt %, from about 1 wt % to about 6 wt %, from about 1 wt % to about 4 wt %, from about 1 wt % to about 2 wt %, from about 3 wt % to about 10 wt %, from about 3 wt % to about 9.5 wt %, from about 3 wt % to about 9 wt %, from about 3 wt % to about 8.5 wt %, from about 3 wt % to about 8 wt %, from about 3 wt % to about 6 wt %, from about 3 wt % to about 4 wt %, from about 5 wt % to about 10 wt %, from about 5 wt % to about 9.5 wt %, from about 5 wt % to about 9 wt %, from about 5 wt % to about 8.5 wt %, from about 5 wt % to about 8 wt %, from about 5 wt % to about 6 wt %, from about 5.5 wt % to about 10 wt %, from about 5.5 wt % to about 9.5 wt %, from about 5.5 wt % to about 9 wt %, from about 5.5 wt % to about 8.5 wt %, from about 5.5 wt % to about 8 wt %, from about 5.5 wt % to about 6 wt %, from about 6 wt % to about 10 wt %, from about 6 wt % to about 9.5 wt %, from about 6 wt % to about 9 wt %, from about 6 wt % to about 8.5 wt %, from about 6 wt % to about 8 wt %, from about 6.5 wt % to about 10 wt %, from about 6.5 wt % to about 9.5 wt %, from about 6.5 wt % to about 9 wt %, from about 6.5 wt % to about 8.5 wt %, from about 6.5 wt % to about 8 wt %, from about 7 wt % to about 10 wt %, from about 7 wt % to about 9.5 wt %, from about 7 wt % to about 9 wt %, from about 7 wt % to about 8.5 wt %, or from about 7 wt % to about 8 wt %, or any and all subranges formed between any of these endpoints.

Suitable separation additives may include conventional or commercially available separation additives. A separation additive may be used alone or in combination with one or more other separation additives.

### Magnetic Separation Additive

In embodiments, the separation additive in the rigid thermoplastic material may be a magnetic separation additive. In embodiments, the magnetic separation additive may be a metal or a metal oxide. For example, in embodiments, the magnetic separation additive may be selected from the group consisting of iron, ferromagnetic steel allow, ferromagnetic stainless steel alloy, synthetic iron oxide with a chemical formula of Fe₃O₄, magnetite, ferrite, strontium ferrite, neodynium mixed oxides, alnico alloys, samarium-cobalt alloys, neodymium alloys, and combinations thereof.

Surprisingly, it has been discovered that, even when only relatively small amounts of magnetic separation additive are included in either the base component or the overmold component, it is possible to separate substantial fractions of the rigid thermoplastic material used to form the base component from substantial fractions of the thermoplastic elastomer material used to form the overmold component and achieve unexpectedly high rates of purity for one or both of these thermoplastic materials.

In embodiments, the magnetic separation additive may be present in the rigid thermoplastic material in an amount from about 0.05 wt % to about 1.0 wt %, based on weight of the rigid thermoplastic material, or any and all subranges formed between these endpoints.

For example, in embodiments, the amount of magnetic separation additive in the rigid thermoplastic material may be, based on weight of the rigid thermoplastic material, greater than or equal to about 0.05 wt %, greater than or equal to about 0.1 wt %, or greater than or equal to about 0.2 wt %; and, less than or equal to about 1 wt %, or less than or equal to about 0.5 wt %. Further, in embodiments, the amount of magnetic separation additive in the rigid thermoplastic material may be, based on weight of the rigid thermoplastic material, from about 0.05 wt % to about 1 wt %, from about 0.05 wt % to about 0.5 wt %, from about 0.1 wt % to about 1 wt %, from about 0.1 wt % to about 0.5 wt %, from about 0.2 wt % to about 1 wt %, or from about 0.2 wt % to about 0.5 wt %, or any and all subranges formed from any of these endpoints.

In embodiments, the magnetic separation additive may have an average particle size D50 from about 0.5 μm to about 200 μm, from about 0.5 μm to about 150 μm, from about 0.5 μm to about 100 μm, from about 0.5 μm to about 50 μm, from about 0.5 μm to about 25 μm, from about 0.5 μm to about 10 μm, from about 1 μm to about 200 μm, from about 1 μm to about 150 μm, from about 1 μm to about 100 μm, from about 1 μm to about 50 μm, from about 1 μm to about 25 μm, from about 1 μm to about 10 μm, from about 5 μm to about 200 μm, from about 5 μm to about 150 μm, from about 5 μm to about 100 μm, from about 5 μm to about 50 μm, from about 5 μm to about 25 μm, from about 5 μm to about 10 μm, from about 10 μm to about 200 μm, from about 10 μm to about 150 μm, from about 10 μm to about 100 μm, from about 10 μm to about 50 μm, from about 10 μm to about 25 μm, from about 25 μm to about 200 μm, from about 25 μm to about 150 μm, from about 25 μm to about 100 μm, from about 25 μm to about 50 μm, from about 50 μm to about 200 μm, from about 50 μm to about 150 μm, from about 50 μm to about 100 μm, from about 100 μm to about 200 μm, from about 100 μm to about 150 μm, or from about 150 μm to about 200 μm, or any and all subranges formed from these endpoints, as measured according to ASTM B822-20.

Suitable commercial embodiments of the magnetic separation additive are available under the POLYMAG brand from Eriez Manufacturing, such as ferromagnetic stainless steel powder grade; under the MICROMAG brand from Quality Magnetite, LLC, such as magnetite grade 5; and under the BAYFERROX brand from LANXESS, such as synthetic iron oxide powder grade 318M.

In embodiments, the magnetic separation additive is not intentionally added and/or not present in the overmold component 104 or the recovered thermoplastic elastomer material. Accordingly, in embodiments, the overmold component 104 and/or the recovered thermoplastic elastomer material may comprise less than about 0.03 wt % of the magnetic separation additive, based on weight of the overmold component and/or the recovered thermoplastic elastomer material, or the overmold component 104 and/or the recovered thermoplastic elastomer material is essentially free of the magnetic separation additive.

### Density Separation Additive

In embodiments, the separation additive in the rigid thermoplastic material may be a density separation additive.

In embodiments, the density separation additive may be an inorganic powder. For example, in embodiments, the density separation additive may be selected from the group consisting of tungsten, tungsten oxide, barium sulfate, copper, ferromagnetic stainless steel, cerium oxide, and combinations thereof.

In embodiments, the density separation additive may be present in the rigid thermoplastic material in an amount from about 5 wt % to about 10 wt %, based on weight of the rigid thermoplastic material, or any and all subranges formed between these endpoints.

For example, in embodiments, the amount of density separation additive in the rigid thermoplastic material may be, based on weight of the rigid thermoplastic material, greater than or equal to about 5 wt %, greater than or equal to about 5.5 wt %, greater than or equal to about 6 wt %, greater than or equal to about 6.5 wt %, or greater than or equal to about 7 wt %; and, less than or equal to about 10 wt %, less than or equal to about 9.5 wt %, less than or equal to about 9 wt %, less than or equal to about 8.5 wt %, or less than or equal to about 8 wt %. Further, in embodiments, the amount of density separation additive in the rigid thermoplastic material may be, based on weight of the rigid thermoplastic material, from about 5 wt % to about 10 wt %, from about 5 wt % to about 9.5 wt %, from about 5 wt % to about 9 wt %, from about 5 wt % to about 8.5 wt %, from about 5 wt % to about 8 wt %, from about 5.5 wt % to about 10 wt %, from about 5.5 wt % to about 9.5 wt %, from about 5.5 wt % to about 9 wt %, from about 5.5 wt % to about 8.5 wt %, from about 5.5 wt % to about 8 wt %, from about 6 wt % to about 10 wt %, from about 6 wt % to about 9.5 wt %, from about 6 wt % to about 9 wt %, from about 6 wt % to about 8.5 wt %, from about 6 wt % to about 8 wt %, from about 6.5 wt % to about 10 wt %, from about 6.5 wt % to about 9.5 wt %, from about 6.5 wt % to about 9 wt %, from about 6.5 wt % to about 8.5 wt %, from about 6.5 wt % to about 8 wt %, from about 7 wt % to about 10 wt %, from about 7 wt % to about 9.5 wt %, from about 7 wt % to about 9 wt %, from about 7 wt % to about 8.5 wt %, or from about 7 wt % to about 8 wt %, or any and all subranges formed from any of these endpoints.

Suitable commercial embodiments of the density separation additive are copper powders available from Makin Metal Powders and tungsten powders from Buffalo Tungsten, such as high density SR or ST grade.

### Overmold Component and Recovered Thermoplastic Elastomer Material

As disclosed herein, the overmold component 104 comprises recovered thermoplastic elastomer material.

In embodiments, the overmold component 102 may be formed from the recovered thermoplastic elastomer material.

In embodiments, the recovered thermoplastic elastomer material may be provided from an antecedent separation process as described elsewhere herein.

In embodiments, the recovered thermoplastic elastomer material may comprise, based on weight of the recovered thermoplastic elastomer material, greater than or equal to about 97 wt % of antecedent thermoplastic elastomer material and less than or equal to about 3 wt % of antecedent rigid thermoplastic material. Further, in embodiments, the recovered thermoplastic elastomer material may comprise, based on weight of the recovered thermoplastic elastomer material, greater than or equal to about 99 wt % of the antecedent thermoplastic elastomer material and less than or equal to about 1 wt % of the antecedent rigid thermoplastic material.

For example, in embodiments, the amount of antecedent thermoplastic elastomer material in the recovered thermoplastic elastomer material may be, based on weight of the recovered thermoplastic elastomer material, greater than or equal to about 97 wt %, greater than or equal to about 97.5 wt %, greater than or equal to about 98 wt %, greater than or equal to about 98.5 wt %, or greater than or equal to about 99 wt %; and, less than or equal to about 100 wt % or less than or equal to about 99.5 wt %. Further, in embodiments, the amount of antecedent thermoplastic elastomer material in the recovered thermoplastic elastomer material may be, based on weight of the recovered thermoplastic elastomer material, from about 97 wt % to about 100 wt %, from about 97 wt % to about 99.5 wt %, from about 97.5 wt % to about 100 wt %, from about 97.5 wt % to about 99.5 wt %, from about 98 wt % to about 100 wt %, from about 98 wt % to about 99.5 wt %, from about 98.5 wt % to about 100 wt %, from about 98.5 wt % to about 99.5 wt %, from about 99 wt % to about 100 wt %, or from about 99 wt % to about 99.5 wt %, or any and all subranges formed from any of these endpoints.

In embodiments, the recovered thermoplastic elastomer material may be essentially free of virgin thermoplastic elastomer material.

In embodiments, the amount of antecedent rigid thermoplastic material in the recovered thermoplastic elastomer material may be, based on weight of the recovered thermoplastic elastomer material, less than or equal to about 3 wt %, less than or equal to about 2.5 wt %, less than or equal to about 2 wt %, less than or equal to about 1.5 wt %, or less than or equal to about 1 wt %; and, greater than or equal to about 0 wt % or greater than or equal to about 0.5 wt %.

For example, in embodiments, the amount of antecedent rigid thermoplastic material in the recovered thermoplastic elastomer material may be, based on weight of the recovered thermoplastic elastomer material, from about 0 wt % to about 3 wt %, from about 0 wt % to about 2.5 wt %, from about 0 wt % to about 2 wt %, from about 0 wt % to about 1.5 wt %, from about 0 wt % to about 1 wt %, from about 0.5 wt % to about 3 wt %, from about 0.5 wt % to about 2.5 wt %, from about 0.5 wt % to about 2 wt %, from about 0.5 wt % to about 1.5 wt %, from about 0.5 wt % to about 1 wt %, or any and all subranges formed from any of these endpoints.

In embodiments, the overmold component 104 may be formed from greater than or equal to about 50 wt %, or greater than or equal to about 75 wt %, of the recovered thermoplastic elastomer material, based on weight of the overmold component 104.

For example, in embodiments, the amount of the recovered thermoplastic elastomer material in the overmold component 104 may be, based on weight of the overmold component 104, greater than or equal to about 50 wt %, greater than or equal to about 55 wt %, greater than or equal to about 60 wt %, greater than or equal to about 65 wt %, greater than or equal to about 70 wt %, or greater than or equal to about 75 wt %; and, less than or equal to about 90 wt % or less than or equal to about 85 wt %; for example, from about 50 wt % to about 90 wt %, from about 50 wt % to about 85 wt %, from about 55 wt % to about 90 wt %, from about 55 wt % to about 85 wt %, from about 60 wt % to about 90 wt %, from about 60 wt % to about 85 wt %, from about 65 wt % to about 90 wt %, from about 65 wt % to about 85 wt %, from about 70 wt % to about 90 wt %, from about 70 wt % to about 85 wt %, from about 75 wt % to about 90 wt %, or from about 75 wt % to about 85 wt %, or any and all subranges formed from any of these endpoints.

In embodiments, the amount of virgin thermoplastic elastomer material in the overmold component may be, based on weight of the overmold component, greater than or equal to about 10 wt % or greater than or equal to about 15 wt %; and, less than or equal to about 50 wt %, less than or equal to about 45 wt %, less than or equal to about 40 wt %, less than or equal to about 35 wt %, less than or equal to about 30 wt %, or less than or equal to about 25 wt %; for example, from about 10 wt % to about 50 wt %, from about 10 wt % to about 45 wt %, from about 10 wt % to about 40 wt %, from about 10 wt % to about 35 wt %, from about 10 wt % to about 30 wt %, from about 10 wt % to about 25 wt %, from about 15 wt % to about 50 wt %, from about 15 wt % to about 45 wt %, from about 15 wt % to about 40 wt %, from about 15 wt % to about 35 wt %, from about 15 wt % to about 30 wt %, or from about 15 wt % to about 25 wt %, or any and all subranges formed from any of these endpoints.

In embodiments, the overmold component may comprise recovered thermoplastic elastomer, optional polymeric chain extender, and optional other additives.

In embodiments, the recovered thermoplastic elastomer material may comprise thermoplastic elastomer, optional polymeric chain extender, and optional other additives.

In embodiments, the antecedent thermoplastic elastomer material may comprise thermoplastic elastomer, optional polymeric chain extender, and optional other additives.

Suitable commercial embodiments of thermoplastic elastomer material are available under the VERSAFLEX brand from Avient Corporation, such as thermoplastic polyurethane grade CE 3120-65.

In embodiments, the overmold component and/or the thermoplastic elastomer material may have a Shore A hardness greater than or equal to about 50 or greater than or equal to about 60; and less than or equal to about 80 or less than or equal to about 70; for example, from about 50 to about 80, from about 50 to about 70, from about 60 to about 80, or from about 60 to about 70, or any and all subranges formed from any of these endpoints.

In embodiments, the overmold component and/or the thermoplastic elastomer material may have a specific gravity greater than or equal to about 1.0 or greater than or equal to about 1.1, and less than or equal to about 1.3 or less than or equal to about 1.2; for example, from about 1.0 to about 1.3, from about 1.0 to about 1.2, from about 1.1 to about 1.3, or from about 1.1 to about 1.2, or any and all subranges formed from any of these endpoints.

In embodiments, the overmold component and/or the thermoplastic elastomer material may have a tensile strength greater than or equal to about 12 MPa or greater than or equal to about 14 MPa; and less than or equal to about 19 MPa or less than or equal to about 17 MPa; for example, from about 12 MPa to about 19 MPa, from about 12 MPa to about 17 MPa, from about 14 MPa to about 19 MPa, from about 14 MPa to about 17 MPa, or any and all subranges formed from any of these endpoints.

In embodiments, the overmold component and/or the thermoplastic elastomer material may have a tensile elongation greater than or equal to about 550% or greater than or equal to about 650%; and less than or equal to about 850% or less than or equal to about 750%; for example, from about 550% to about 850%, from about 550% to about 750%, from about 650% to about 850%, or from about 650% to about 750%, or any and all subranges formed from any of these endpoints.

In embodiments, the overmold component and/or the thermoplastic elastomer material may have a 300% tensile modulus greater than or equal to about 0.07 MPa, greater than or equal to about 0.1 MPa, greater than or equal to about 0.5 MPa, greater than or equal to about 1 MPa, or greater than or equal to about 3 MPa; and less than or equal to about 15 MPa, less than or equal to about 12 MPa, less than or equal to about 10 MPa, less than or equal to about 8 MPa, or less than or equal to about 6 MPa; for example, from about 0.07 MPa to about 15 MPa, from about 0.07 MPa to about 12 MPa, from about 0.07 MPa to about 10 MPa, from about 0.07 MPa to about 8 MPa, from about 0.07 MPa to about 6 MPa, from about 0.1 MPa to about 15 MPa, from about 0.1 MPa to about 12 MPa, from about 0.1 MPa to about 10 MPa, from about 0.1 MPa to about 8 MPa, from about 0.1 MPa to about 6 MPa, from about 0.5 MPa to about 15 MPa, from about 0.5 MPa to about 12 MPa, from about 0.5 MPa to about 10 MPa, from about 0.5 MPa to about 8 MPa, from about 0.5 MPa to about 6 MPa, from about 1 MPa to about 15 MPa, from about 1 MPa to about 12 MPa, from about 1 MPa to about 10 MPa, from about 1 MPa to about 8 MPa, from about 1 MPa to about 6 MPa, from about 3 MPa to about 15 MPa, from about 3 MPa to about 12 MPa, from about 3 MPa to about 10 MPa, from about 3 MPa to about 8 MPa, or from about 3 MPa to about 6 MPa, or any and all subranges formed from any of these endpoints.

### Thermoplastic Elastomer

In embodiments, the thermoplastic elastomer material (either as the recovered thermoplastic elastomer material or the antecedent thermoplastic elastomer material) may comprise thermoplastic elastomer.

Suitable thermoplastic elastomers may include conventional or commercially available thermoplastic elastomers. A thermoplastic elastomer may be used alone or in combination with one or more other thermoplastic elastomers.

In embodiments, the thermoplastic elastomer may be selected from the group consisting of thermoplastic polyurethanes (TPU) and styrenic block copolymers (SBC), wherein the styrenic block copolymers (SBC) are selected from the group consisting of styrene-ethylene/butylene-styrene (SEBS) block copolymers, styrene-ethylene/propylene-styrene (SEPS), styrene-ethylene/ethylene/propylene-styrene (SEEPS), styrene-isobutylene-styrene (SIBS), styrene-butadiene-styrene (SBS), styrene-isoprene-styrene (SIS), and combinations thereof.

In embodiments, the thermoplastic elastomer may be present in the thermoplastic elastomer material in an amount from about 50 wt % to about 99.9 wt %, based on weight of the thermoplastic elastomer material, or any and all subranges formed between these endpoints. For example, in embodiments, the thermoplastic elastomer may be present in an amount in the thermoplastic elastomer material from about 60 wt % to about 99.9 wt %, or from about 70 wt % to about 99.9 wt %, or from about 80 wt % to about 99.9 wt %, or from about 90 wt % to about 99.9 wt %, or from about 95 wt % to about 99.9 wt %, based on weight of the thermoplastic elastomer material, or any and all subranges formed between any of these endpoints.

### Polymeric Chain Extender

In embodiments, the overmold component and/or the thermoplastic elastomer material (as the antecedent thermoplastic elastomer material or the recovered thermoplastic elastomer material) may further comprise polymeric chain extender.

For example, in embodiments, the overmold component and/or the thermoplastic elastomer material (as the antecedent thermoplastic elastomer material or the recovered thermoplastic elastomer material) may further comprise polymeric chain extender when the thermoplastic elastomer is selected from thermoplastic polyurethanes. In these embodiments, adding a polymeric chain extender to a thermoplastic elastomer material used to form an overmold component 104 may improve the tensile strength of the overmold component 104.

Suitable polymeric chain extenders may include conventional or commercially available polymeric chain extenders. A polymeric chain extender may be used alone or in combination with one or more other polymeric chain extenders.

For example, in embodiments, the polymeric chain extender may be selected from functional styrene acrylic copolymers with epoxy groups.

In embodiments, the polymeric chain extender may be present in an amount from about 0.2 wt % to about 1.0 wt %, based on weight of the overmold component 104 or based on weight of the thermoplastic elastomer material if and as applicable.

In embodiments, the amount of polymeric chain extender in the overmold component 104 may be, based on weight of the overmold component 104, greater than or equal to about 0.2 wt % or greater than or equal to about 0.4 wt %. In embodiments, the amount of polymeric chain extender in the overmold component 104, based on a total weight of the overmold component 104, may be less than or equal to about 2 wt %, less than or equal to about 1.5 wt %, less than or equal about 1 wt % or less than or equal to about 0.8 wt %. In embodiments, the amount of polymeric chain extender in the overmold component 104, based on a total weight of the overmold component 104, may be from about 0.2 wt % to about 2 wt %, from about 0.2 wt % to about 1.5 wt %, from about 0.2 wt % to about 1 wt %, from about 0.2 wt % to about 0.8 wt %, from about 0.4 wt % to about 2 wt %, from about 0.4 wt % to about 1.5 wt %, from about 0.4 wt % to about 1 wt %, or from about 0.4 wt % to about 0.8 wt %, or any and all subranges formed from any of these endpoints.

Suitable commercial embodiments of the polymeric chain extender are available under the JONCRYL brand from BASF, such as functional styrene acrylic copolymer with epoxy groups grade ADR 4400.

### Other Additives

In embodiments, one or both of the rigid thermoplastic material and the thermoplastic elastomer material may further comprise one or more optional other additives.

Suitable additives may include conventional or commercially available plastics additives. Those skilled in the art of thermoplastics compounding, without undue experimentation, may select suitable additives from available references, for example, E. W. Flick, “Plastics Additives Database,” Plastics Design Library (Elsevier 2004).

Optional other additives may be used in any amount that is sufficient to obtain a desired processing or performance property for the material or component formed therefrom. The amount should not be wasteful of the additive nor detrimental to the processing or performance.

For example, in embodiments, one or more optional other additives may be present in the material in an amount from 0 wt % to about 40 wt %, or from about 0.01 wt % to about 20 wt %, or from about 0.1 wt % to about 10 wt %, based on weight of the material, or any and all subranges formed between any of these endpoints.

Non-limiting examples of optional other additives may include adhesion promoters; antioxidants; biocides; anti-fogging agents; anti-static agents; bonding agents and bonding polymers; dispersants; fillers; flame retardants and smoke suppressants; impact modifiers; initiators; lubricants; micas; colorants (pigments and/or dyes); plasticizers; processing aids; release agents; silanes, titanates, and zirconates; slip and anti-blocking agents; stearates; ultraviolet light absorbers; viscosity regulators; waxes; and combinations thereof.

In embodiments, one or both of the rigid thermoplastic material and the thermoplastic elastomer material may comprise inorganic filler. For example, in embodiments, the inorganic filler may be selected from the group consisting of chopped glass fibers, glass beads, talc, clays, calcium carbonates, and combinations thereof.

In embodiments, one or both of the rigid thermoplastic material and the thermoplastic elastomer material may comprise antioxidants. Suitable commercial embodiments of antioxidants are available under the IRGANOX brand from BASF, such as grade B225.

### Photoluminescent Marker

In embodiments, the article may further comprise a photoluminescent marker.

In embodiments, the photoluminescent marker may be affixed or applied onto an outer surface of the article. Additionally or alternatively, in embodiments, the photoluminescent marker may be incorporated into the base component (and/or the rigid thermoplastic material used to form the base component) and/or the overmold component (and/or the thermoplastic elastomer material used to form the overmold component).

In embodiments, the photoluminescent marker may emit a light spectrum that is visible to a human eye under normal lighting conditions. Likewise, in embodiments, the photoluminescent marker may emit a light spectrum that is visible to a human eye and/or detectable by a sensor when excited by an ultraviolet (UV), visible, or near infrared (IR) light source.

Accordingly, the photoluminescent marker may be used to facilitate identifying the article as a “recycle friendly” article. For example, in embodiments, the photoluminescent marker may comprise a brand or logo or other identifier that is visible to the human eye and indicates to a consumer that the article is a “recycle friendly” article. Further, in embodiments, the photoluminescent marker may be detectable by an automated optical sorter in a recycling process so that the “recycle friendly” articles may be sorted from other articles that are not “recycle friendly” prior to a granulation step.

In embodiments, the photoluminescent marker is thermally resistant such that it can withstand repeated heat exposures or heat histories that may be involved in multiple loops of recycling the articles and forming new articles by extrusion and/or molding processes.

In embodiments, the photoluminescent marker may comprise a thermoplastic carrier and at least one inorganic fluorophore.

In embodiments, the thermoplastic carrier may be the same as either the thermoplastic resin or the thermoplastic elastomer as described hereinabove.

In embodiments, the inorganic fluorophore may be selected from lanthanide-doped silicates or aluminates, manganese-doped silicates or aluminates, up-converting inorganic nanocrystals or lanthanide-doped nanoparticles (such as lanthanide-doped fluorides or lanthanide-doped metal oxide nanoparticles), semiconductor quantum dots, and combinations thereof.

In embodiments, the inorganic fluorophore has an average particle size that ranges from about 5 nm to about 100 microns.

In embodiments, the inorganic fluorophore is present in the photoluminescent marker from about 25 ppm to about 5000 ppm, based on weight on the photoluminescent marker.

In embodiments, the photoluminescent marker may be applied to an outer surface of the article by overmolding, mechanical interlocking, or direct printing without use of adhesive.

### Additional Component

In embodiments, the article may further comprise an additional component comprising an additional thermoplastic material, wherein the additional thermoplastic material is (a) the same as the rigid thermoplastic material, or (b) the same as the recovered thermoplastic elastomer material, or (c) different from each of the rigid thermoplastic material and the recovered thermoplastic elastomer material.

In embodiments, at least a portion of the additional component may be affixed to at least a portion of the overmold component or at least a portion of the base component or both.

In embodiments, the additional component may comprise a separation additive that is the same as, or different from, the separation additive included in the rigid thermoplastic material.

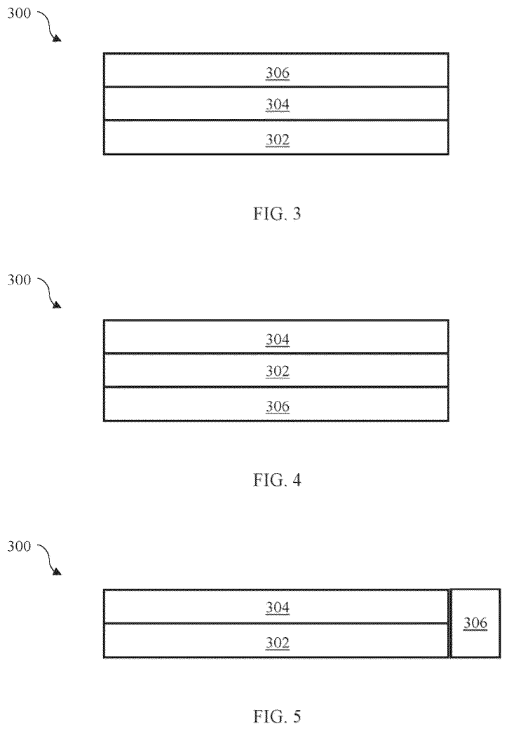

Referring now to FIGS. 3-5, an article 300 comprising a base component 302 comprising rigid thermoplastic material and an overmold component 304 comprising recovered thermoplastic elastomer material may further comprise an additional component 306 comprising an additional thermoplastic material. The additional component 306 may be affixed to overmold component 304 as shown in FIG. 3, to base component 302 as shown in FIG. 4, or both component 302 and component 304 as shown in FIG. 5. Non-limiting examples of methods of affixing component 306 may include overmolding, gluing, and mechanical fastening.

### Protective Cover for Electronic Device and System Thereof

In embodiments, the article described herein may be a protective case or cover for an electronic device, wherein the electronic device is capable of sending and/or receiving wireless telecommunication signals at frequencies between about 1 GHz and about 50 GHz.

Non-limiting examples of such electronic devices include mobile phones, smartphones, tablets, computers, and other devices with connectivity via a 5G broadband cellular network.

In embodiments, a lower dielectric constant may be preferred for high frequency telecommunication applications. In these embodiments, the rigid thermoplastic material of the protective case or cover may comprise a separation additive, wherein the separation additive is a magnetic separation additive, and wherein the magnetic separation additive is ferromagnetic stainless steel, magnetite, or a combination thereof. As exemplified in the Examples section, ferromagnetic stainless steel or magnetite may relatively lower dielectric constant as compared to other magnetic separation additives.

In embodiments, a system comprises an electronic device capable of sending and/or receiving a wireless telecommunications signals at frequencies between about 1 GHz and about 50 GHz and a protective case or cover comprising the article as described herein. In these embodiments, the protective case or cover encases at least a portion of the electronic device and does not substantiality interfere with the electronic device sending and/or receiving the wireless telecommunication signal.

### EXAMPLES

Non-limiting examples of various embodiments of the disclosed invention are provided.

Table 1 shows ingredients used to form Comparative Examples C1 to C4 and Examples E1 to E15.

TABLE 1

| Ingredient | Brand and Grade | Source |
|---|---|---|
| thermoplastic elastomer | VERSAFLEX CE 3120-65 | Avient |
| (thermoplastic | | Corporation |
| polyurethane) | | |
| rigid thermoplastic | MAKROLON 2407 | Covestro AG |
| (polycarbonate) | | |
| separation additive | POLYMAG ferromagnetic | Eriez |
| (magnetic separation | stainless steel powder | Mfg. Co. |
| additive) | (hereinafter “POLYMAG”) | |
| separation additive | MICROMAG 5 magnetite | Quality |
| (magnetic separation | powder (hereinafter | Magnetite LLC |
| additive) | “MICROMAG 5”) | |
| separation additive | BAYFERROX 318M | LANXESS AG |
| (magnetic separation | synthetic iron oxide | |
| additive) | (hereinafter | |
| | “BAYFERROX 318M”) | |
| polymeric chain | JONCRYL ADR 4400 | BASF |
| extender (functional | | |
| styrene acrylic | | |
| copolymer with | | |
| epoxy groups) | | |
| antioxidant | IRGANOX B225 | BASF |

Table 2 below shows Comparative Example C1 and Examples E1 to E3, which were regrinds of antecedent articles comprising a VERSAFLEX CE 3120-65 (i.e., thermoplastic elastomer) component and a MAKROLON 2407 (i.e., rigid thermoplastic) component with different loading of POLYMAG in either the VERSAFLEX CE 3120-65 component or the MAKROLON 2407 component as indicated in Table 2. The antecedent articles of Comparative Example C1 and Examples E1-E3 were in the form of flat plaques of 100 mm×100 mm×3.2 mm. A VERSAFLEX CE 3120-65 component was overmolded as a 1.6 mm thick layer onto a side of a previously formed 1.6 mm thick MAKROLON 2407 component such that the VERSAFLEX CE 3120-65 component completely covered the overmolded side MAKROLON 2407 component. The weight ratio of the VERSAFLEX CE 3120-65 component and the MAKROLON 2407 component in each of the antecedent articles of Comparative Example C1 and Examples E1 to E3 was 48:52. The regrinds were generated by grinding the plaques of each antecedent article to smaller particles with lateral sizes between 0.5 mm and 5 mm, which was controlled by using a perforated metal screen in the grinder with the diameter of the perforated holes of 5 mm.

TABLE 2

| | | Amount of POLYMAG |
|---|---|---|
| | | (wt %, based on weight |
| | | of rigid thermoplastic or |
| Sample | Location of POLYMAG | thermoplastic elastomer) |
| E1 | MAKROLON 2407 | 1.0 |
| E2 | MAKROLON 2407 | 0.5 |
| E3 | MAKROLON 2407 | 0.2 |
| C1 | VERSAFLEX CE 3120-65 | 0.5 |

Referring back to FIG. 2, a pilot-scale magnetic pulley separator 200 with a 20″ wide belt conveyor 202 and a POLYMAG magnetic roll 204 was used to separate regrind of Comparative Example C1 and Examples E1-E3. The roll 204 was constructed of discs of neodymium-boron-iron permanent magnets sandwiched with steel pole pieces. The steel poles had been magnetically induced to the saturation point of approximately 24,000 gauss. The thickness of the belt 202 was about 0.25 mm. The separator 200 was set up with one splitter 206 and two collection bins 208, 210. The collection bin 208 collected predominantly regrind with no POLYMAG and the collection bin 210 collected predominantly regrind with POLYMAG. The splitter position was adjustable and was set to achieve a high-purity of VERSAFLEX CE 3120-65 rich fraction. The feed rate was 300 lb/hr/foot belt width. The belt speed was 160 ft/min. The samples were run for a one-pass test, the results of which are shown in Table 3.

As used herein, the term “purity of VERSAFLEX CE 3120-65 rich fraction” refers to the weight percentage of neat VERSAFLEX CE 3120-65 in the VERSAFLEX CE 3120-65 rich fraction.

As used herein, the term “purity of MAKROLON 2407 rich fraction” refers to the weight percentage of neat MAKROLON 2407 in the MAKROLON 2407 rich fraction.

The recovery rate of neat VERSAFLEX CE 3120-65 (i.e., thermoplastic elastomer), shown as “VERSAFLEX” in equation, after the separation of each regrind was calculated using the equation below and is listed Table 3 in units of wt %. As noted above, the VERSAFLEX CE 2130-65 component occupied 48 wt % of the total weight of the regrind in Comparative Example C1 and Examples E1-E3, which is why the total weight of the regrind was multiplied by 0.48.

$$Recovery rate of neat VERSAFLEX = \frac{\begin{matrix}weight of the VERSAFLEX rich fraction \times \\ purity of the VERSAFLEX rich fraction\end{matrix}}{total weight of the regrind \times 0.48} \times 100$$

The recovery rate of neat MAKROLON 2407 (i.e., rigid thermoplastic), shown as “MAKROLON” in equation, after the separation of each regrind was calculated using the equation below and is listed in Table 3 in units of wt %. As noted above, the MAKROLON 2407 component occupied 52 wt % of the total weight of the regrind in Comparative Example C1 and Examples E1-E3, which is why the total weight of the regrind was multiplied by 0.52.

$$Recovery rate of neat MAKROLON = \frac{\begin{matrix}weight of the MAKROLON rich fraction \times \\ purity of the MAKROLON rich fraction\end{matrix}}{total weight of the regrind \times 0.52} \times 100$$

TABLE 3

| Sample | E1 | E2 | E3 | C1 |
|---|---|---|---|---|
| Purity of VERSAFLEX | 100% | 99% | 97% | 87% |
| CE 3120-65 rich fraction | | | | |
| (Contaminant: MAKROLON 2407) | | | | |
| Purity of MAKROLON 2407 rich | 83% | 80% | 83% | 100% |
| fraction (Contaminant: | | | | |
| VERSAFLEX CE 3120-65) | | | | |
| Recovery rate of | 78% | 73% | 78% | 100% |
| neat VERSAFLEX 3120-65 | | | | |
| Recovery rate of neat | 100% | 99% | 97% | 86% |
| MAKROLON 2407 | | | | |

As shown in Table 3, Examples E1 to E3, regrinds of the antecedent articles with 1.0 wt %, 0.5 wt %, and 0.2 wt % POLYMAG, respectively, in the MAKROLON 2407 components, resulted in a significantly higher purity of the VERSAFLEX CE 3120-65 rich fraction than Comparative Example C1, regrind of the antecedent article with 0.5 wt % POLYMAG in the VERSAFLEX CE 3120-65 component. Moreover, Examples Elto E3 had an acceptable recovery rate of neat VERSAFLEX 3120-65 for a closed-loop recycling process (i.e., greater than 50%). As exemplified by Table 3, including a separation additive in the rigid thermoplastic material results in a higher purity as compared to including the separation additive in the thermoplastic elastomer material and an acceptable recovery rate for a closed-loop recycling process.

As also shown in Table 3, Examples E1 to E3 resulted in a purity of the VERSAFLEX CE 3120-65 rich fraction of 100%, 99%, and 97%, respectively. The purity of the VERSAFLEX CE 3120-65 rich fraction of Example E1 was slightly higher than that of Example E2, which was slightly higher than that of Example E3. While not wishing to be bound by theory, it is believed that the higher loading level of magnetic separation additive in the polycarbonate component (i.e., the rigid thermoplastic component) resulted in a higher purity thermoplastic elastomer rich fraction, which was essentially free of magnetic separation additive.

Referring now to Table 4, Examples E2 and E3 were run for a three-pass test, the results of which are shown in Table 4. During the three-pass test, the VERSAFLEX CE3120-65 (i.e., thermoplastic elastomer) rich fraction resulting from the first pass was run through the magnetic separator for the second pass, and the VERSAFLEX CE3120-65 rich fraction resulting from the second pass was run through the magnetic separator for the third pass. The feed rate was reduced to 177 lb/hr/foot belt for the second and third passes, while the first pass still used a 300 lb/hr/foot rate.

TABLE 4

| | | Purity of VERSAFLEX |
|---|---|---|
| | | CE 3120-65 rich fraction |
| Sample | Pass | (Contaminant: polycarbonate) |
| E2 | First | 99% |
| E2 | Second | 99% |
| E2 | Third | 100% |
| E3 | First | 97% |
| E3 | Second | 98% |
| E3 | Third | 98% |

As shown in Table 4, there was a minor improvement in the purity of the VERSAFLEX CE 3120-65 rich fraction from the first pass to the second and/or third passes.

To simulate a closed-loop recycling process of thermoplastic elastomer that is recovered from antecedent overmolded articles comprising an overmold component based on VERSAFLEX CE3120-65 and a base component based on MAKROLON 2407, the compositions of Comparative Example C3 and Examples E4 to E7 as shown in Table 5 were mixed and compounded using a twin-screw extruder, and then molded to 3.2 mm thick flat plaques. Comparative Example C2 was directly molded to a 3.2 mm thick flat plaque. The flat plaques of each example were then die punched to the standard ASTM D412-type C tensile bars for tensile testing. The tensile strength at break of Comparative Examples C2 and C3 and Examples E4 to E7 were measured according to ASTM D412 as shown in Table 5. Note the compositions in Table 5 are described in wt %, i.e., the weight percentage of each ingredient relative to the total weight of each composition. VERSAFLEX CE 3120-65 Regrind 1 and Regrind 2 were to simulate the VERSAFLEX rich fractions with high purities of neat VERSAFLEX CE3120-65 (99% and 97%, respectively) that were recovered from a magnetic separation process as described above.

TABLE 5

| Sample | C2 | C3 | E4 | E5 | E6 | E7 |
|---|---|---|---|---|---|---|
| VERSAFLEX CE 3120-65 | 100.0 | 99.8 | 24.8 | 49.8 | 49.8 | 49.4 |
| (virgin and neat) | | | | | | |
| VERSAFLEX CE 3120-65 | — | — | — | — | 50 | — |
| Regrind 1 (containing 1 wt % | | | | | | |
| MAKROLON 2407 | | | | | | |
| contaminant) | | | | | | |
| VERSAFLEX CE 3120-65 | — | — | 75 | 50 | — | 50 |
| Regrind 2 (containing 3 wt % | | | | | | |
| MAKROLON 2407 | | | | | | |
| contaminant) | | | | | | |
| JONCRYL ADR 4400 | — | — | — | — | — | 0.4 |
| IRGANOX B225 | — | 0.2 | 0.2 | 0.2 | 0.2 | 0.2 |
| Total of each composition, | 100.0 | 100.0 | 100.0 | 100.0 | 100.0 | 100.0 |
| wt % | | | | | | |
| Tensile strength at break | 17.7 | 16.8 | 15.0 | 15.2 | 16.5 | 16.6 |
| (MPa) | | | | | | |
| Tensile strength relative | — | 94.9 | 84.7 | 85.9 | 93.2 | 93.8 |
| to C2 (%) | | | | | | |

As shown in Table 5, Examples E4 to E6, overmolded components made with VERSAFLEX CE 2120-65 Regrind 1 or Regrind 2 (containing 1 wt % or 3 wt % MAKROLON 2407 contaminant relative to the weight of each regrind), had a lower tensile strength as compared to Comparative Example C3, an overmolded component made without VERSAFLEX CE 3120-65 regrind in the compounding and molding process. Without intending to be bound by theory, higher contaminant levels in Examples E4 and E5 resulted in even lower tensile strength than Example E6. However, Example E7, including 0.4 wt % JONCRYL ADR 4400 used in the compounding step of the closed-loop recycling process, had an improved tensile strength as compared to Example E5, which included the same weight percentage of VERSAFLEX CE 3120-65 Regrind 2 as Example E7 and no JONCRYL ADR 4400. As exemplified by Table 5, inclusion of a polymeric chain extender with epoxy functional groups in the compounding step of the closed-loop recycled overmold component comprising thermoplastic polyurethane improves the tensile strength of the recycled overmold component.

Referring now to Table 6, Comparative Example C4 and Examples E8 to E15, which were base components (i.e., no overmold component) comprising MAKROLON 2407 with a different loading of POLYMAG, MICROMAG5, or BAYFERROX 318 M as indicated in Table 6, are shown with their respective dielectric constants at 40 GHz.

TABLE 6

| | | Amount of separation | |
|---|---|---|---|
| | | additive (wt %, based | Dielectric |
| | Type of | on weight of the | constant |
| Sample | separation additive | polycarbonate material) | at 40 GHz |
| C4 | — | — | 2.748 |
| E8 | POLYMAG | 0.12 | 2.741 |
| E9 | POLYMAG | 0.5 | 2.754 |
| E10 | POLYMAG | 2 | 2.786 |
| E11 | MICROMAG 5 | 0.12 | 2.747 |
| E12 | MICROMAG 5 | 0.5 | 2.755 |
| E13 | BAYFERROX 318M | 0.12 | 2.748 |
| E14 | BAYFERROX 318M | 0.5 | 2.783 |
| E15 | BAYFERROX 318M | 2 | 2.802 |

As shown in Table 6, the dielectric constant of MAKROLON 2407 changed by less than 0.3% when up to 0.5 wt % of POLYMAG (i.e., ferromagnetic stainless steel powder) or MICROMAG 5 (i.e., magnetite powder) was added. BAYFERROX 318 M (i.e., synthetic iron oxide) caused a higher dielectric constant increase at the same loading level as POLYMAG and MICROMAG 5. As exemplified by Table 7, ferromagnetic stainless steel and magnetite may be preferred as magnetic separation additives for such applications.

Every document cited herein is incorporated herein by reference in its entirety unless otherwise specified. The citation of any document is not to be construed as an admission that it is prior art with respect to any invention disclosed or claimed herein. To the extent that any meaning or definition of a term in this document conflicts with any meaning or definition of the same term in a document incorporated by reference, the meaning or definition assigned to that term in this document shall govern.

It will be apparent that modifications and variations are possible without departing from the scope of the disclosure defined in the appended claims. Although some aspects of the present disclosure are identified herein as preferred or particularly advantageous, it is contemplated that the present disclosure is not necessarily limited to these aspects.

What is claimed is:

1. An article comprising:
(a) a base component comprising rigid thermoplastic material; and
(b) an overmold component comprising recovered thermoplastic elastomer material;
wherein the recovered thermoplastic elastomer material comprises:
(i) greater than or equal to about 97 wt % of antecedent thermoplastic elastomer material, based on weight of the recovered thermoplastic elastomer material; and
(ii) less than or equal to about 3 wt % of antecedent rigid thermoplastic material, based on weight of the recovered thermoplastic elastomer material.

2. The article of claim 1, wherein the recovered thermoplastic elastomer material comprises:
(i) greater than or equal to about 99 wt % of the antecedent thermoplastic elastomer material, based on weight of the recovered thermoplastic elastomer material; and
(ii) less than or equal to about 1 wt % of the antecedent rigid thermoplastic material, based on weight of the recovered thermoplastic elastomer material.

3. The article of claim 1, wherein the recovered thermoplastic elastomer material is essentially free of virgin thermoplastic elastomer and is obtained from an antecedent separation process in which the antecedent thermoplastic elastomer material is separated from at least a portion of the antecedent rigid thermoplastic material to provide the recovered thermoplastic elastomer material.

4. The article of claim 3, wherein the recovered thermoplastic elastomer material comprises regrind of an antecedent article or antecedent scrap material from an antecedent process for manufacturing or recycling the antecedent article, wherein the antecedent article or the antecedent scrap material comprises the antecedent thermoplastic elastomer material overmolded onto the antecedent rigid thermoplastic material, and wherein the regrind of the antecedent article or the antecedent scrap material is subjected to the antecedent separation process in which the antecedent thermoplastic elastomer material is separated from at least a portion of the antecedent rigid thermoplastic material to provide the recovered thermoplastic elastomer material.

5. The article of claim 1, wherein the rigid thermoplastic material comprises a separation additive, and wherein the separation additive is present in an amount from about 0.05 wt % to about 10 wt %, based on weight of the rigid thermoplastic material.

6. The article of claim 5, wherein the separation additive is a magnetic separation additive, the magnetic separation additive is present in an amount from about 0.05 wt % to about 1.0 wt %, based on weight of the rigid thermoplastic material, and the magnetic separation additive is selected from the group consisting of iron, ferromagnetic steel alloy, ferromagnetic stainless steel alloy, synthetic iron oxide with a chemical formula of Fe₃O₄, magnetite, ferrite, strontium ferrite, neodynium mixed oxides, alnico alloys, samarium-cobalt alloys, neodymium alloys, and combinations thereof.

7. The article of claim 6, wherein the recovered thermoplastic elastomer material, or the overmold component, comprises less than about 0.03 wt % of the magnetic separation additive, based on weight of the recovered thermoplastic elastomer material or the overmold component, or is essentially free of the magnetic separation additive.

8. The article of claim 5, wherein the separation additive is a density separation additive, the density separation additive is present in an amount from about 5 wt % to about 10 wt %, based on weight of the rigid thermoplastic material, and the density separation additive is selected from the group consisting of tungsten, tungsten oxide, barium sulfate, copper, ferromagnetic stainless steel, cerium oxide, and combinations thereof.

9. The article of claim 1, wherein the overmold component is formed from greater than or equal to about 50 wt %, or greater than or equal to about 75 wt %, of the recovered thermoplastic elastomer material, based on weight of the overmold component.

10. The article of claim 1, wherein at least a portion of the overmold component is affixed by interfacial bonding onto at least a portion of the base component.

11. The article of claim 1, wherein:
(a) the rigid thermoplastic material comprises:
(i) thermoplastic resin selected from the group consisting of polycarbonates, thermoplastic polyesters, polyamides, aliphatic polyketones, acrylonitrile butadiene styrenes, polypropylenes, and combinations thereof; and
(ii) separation additive; and
(iii) optional other additives; and
(b) the recovered thermoplastic elastomer material comprises:
(i) thermoplastic elastomer selected from the group consisting of thermoplastic polyurethanes (TPU) and styrenic block copolymers (SBC), and wherein the styrenic block copolymers (SBC) are selected from the group consisting of styrene-ethylene/butylene-styrene (SEBS) block copolymers, styrene-ethylene/propylene-styrene (SEPS), styrene-ethylene/ethylene/propylene-styrene (SEEPS), styrene-isobutylene-styrene (SIBS), styrene-butadiene-styrene (SBS), styrene-isoprene-styrene (SIS), and combinations thereof;
(ii) optional polymeric chain extender; and
(iii) optional other additives;
wherein the optional other additives in the rigid thermoplastic material and/or the recovered thermoplastic elastomer material are independently selected from one or more of the group consisting of adhesion promoters; antioxidants; biocides; anti-fogging agents; anti-static agents; bonding agents; dispersants; fillers; flame retardants and smoke suppressants; impact modifiers; initiators; lubricants; micas; colorants (pigments and/or dyes); plasticizers; processing aids; release agents; silanes, titanates, and zirconates; slip and anti-blocking agents; stearates; ultraviolet light absorbers; viscosity regulators; and waxes.

12. The article of claim 11, wherein the thermoplastic elastomer is selected from thermoplastic polyurethanes and the overmold component further comprises a polymeric chain extender, wherein the polymeric chain extender is selected from functional styrene acrylic copolymers with epoxy groups, and wherein the polymeric chain extender is present from about 0.2 wt % to about 2.0 wt %, based on weight of the overmold component.

13. The article of claim 1, wherein the rigid thermoplastic material comprises virgin thermoplastic resin, recovered thermoplastic resin, or combinations thereof.

14. The article of claim 1, wherein the article further comprises a photoluminescent marker.

15. The article of claim 14, wherein the photoluminescent marker is affixed onto an outer surface of the article.

16. The article of claim 14, wherein the photoluminescent marker is incorporated into the rigid thermoplastic material used to form the base component or the recovered thermoplastic elastomer material used to form the overmold component or both.

17. The article of claim 14, wherein the photoluminescent marker comprises at least one inorganic fluorophore selected from the group consisting of lanthanide-doped silicates or aluminates; manganese-doped silicates or aluminates; lanthanide-doped nanoparticles; semiconductor quantum dots; and combinations thereof.

18. The article of claim 1, wherein the article is a protective case or cover for an electronic device, and the electronic device is capable of sending and/or receiving wireless telecommunication signals at frequencies between about 1 GHz and about 50 GHz.

19. The article of claim 15, wherein the rigid thermoplastic material comprises a separation additive, the separation additive is a magnetic separation additive, and the magnetic separation additive is ferromagnetic stainless steel, magnetite, or a combination thereof.

20. A system comprising:
(a) an electronic device capable of sending and/or receiving a wireless telecommunications signals at frequencies between about 1 GHz and about 50 GHz; and
(b) a protective cover comprising the article of claim 1, wherein the protective cover encases at least a portion of the electronic device and does not substantiality interfere with the electronic device sending and/or receiving the wireless telecommunication signal.
